(19) United States
(12) Patent Application Publication
(10) Pub. No.: US 2004/0183046 A1
(43) Pub. Date: Sep. 23, 2004

(54) Anti-scaling control element for a rotary control valve

(76) Inventor: Anthony J. Bickell, Burleigh Waters (AU)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/391,692

(22) Filed: Mar. 19, 2003

(51) Int. Cl. F16K 5/06

(52) U.S. Cl. 251/315.16

(57) ABSTRACT

A control element for a rotary control valve is attached to a rotating shaft by at least one ear. The control element includes at least two surfaces, the first surface being generally sealable with a flow ring. The second surface is generally recessed from the first surface to facilitate fluid flowing through the valve across the first surface to prevent scaling or buildup of foreign material on that surface.

### TECHNICAL FIELD

The present anti-scaling control element relates generally to rotary control valves, and more particularly to a ball valve that inhibits scale formation.

### BACKGROUND

Ball valves are commonly used to control the flow of a fluid in a pipe. These valves are particularly advantageous for controlling the flow of erosive slurries, such as those found in the mining industry. Unlike butterfly valves and eccentric plug valves, ball valves allow a fluid flow path that is substantially parallel to the flow in the pipe. Parallel flow reduces impingement erosion of valve components and downstream pipe.

Typical ball valves include a generally hemispherical or ball-shaped control element that is movable between open and closed positions. In the closed position, a curved surface of the control element engages a sealing surface to prevent or regulate fluid flow through the valve body. In the open position, fluid may primarily flow past an inner sealing surface of the control element and through the flow ring. Internal features of the valve or control element, however, may reduce flow velocity through some regions of the valve. For example, one region of low velocity flow in many ball valves is located between the outside surface of the ball and the flow ring when the valve is in an open position.

Some erosive slurries may form scale on the valve components in regions of reduced velocity flow or stagnation. Scale can eventually inhibit operation of the valve, which may cause expensive and time-consuming maintenance or even dangerous working conditions for personnel. In some cases, slurries may form an extremely hard scale that may cause unusually extensive downtime or even require valve replacement. Many thousands of dollars may be lost if a process is halted to maintain or replace a non-operational valve.

A ball valve that does not create regions of low velocity flow that are likely to promote scale formation is, therefore, desirable.

### SUMMARY

In accordance with one embodiment of the present control element, a rotary control valve is attached to a rotating shaft by at least one ear. The control element includes first and second surfaces, the first surface being generally sealable with a flow ring. The second surface is generally recessed from the first surface to facilitate fluid flowing through the valve across the first surface to prevent scaling or buildup of foreign material on the second surface.

In another embodiment of the present control element, a rotary control valve has a valve body and a control element that rotates within the valve body to control fluid flow through the valve body. The control element has a surface area that seats with a flow ring of the valve body to prevent fluid from flowing through the valve body. The control element also has a second surface that is generally recessed in relation to the first surface to create a secondary flow path through the valve body and across the first surface when the valve is in an open position to prevent scale or material build up along the first surface.

### BRIEF DESCRIPTION OF THE DRAWINGS

The features of this present control element which are believed to be novel and are set forth with particularity in the appended claims. The present control element may be best understood by reference to the following description taken in conjunction with the accompanying drawings in which like reference numerals identify like elements in the several figures and in which:

FIG. 1 is a cross-sectional view of a fluid control valve according to the prior art.

FIG. 2 is a cross-sectional view of a fluid control valve according to one embodiment of the present control element.

FIG. 3 is a plan, partial sectional view of a control element of a fluid control valve according to one embodiment of the present control element.

FIG. 4 is an elevation sectional view of a control element of a fluid control valve according to one embodiment of the present control element.

FIG. 5 is an elevation sectional view of a control element of a fluid control valve according to one embodiment of the present invention.

FIG. 6 is a plan, partial sectional view of a control element of a fluid control valve according to another embodiment of the present control element.

### DETAILED DESCRIPTION

Although the making and using of various embodiments of the present control element are discussed in detail below, it should be appreciated that the present control element provides many applicable inventive concepts that may be embodied in a wide variety of specific contexts. The specific embodiments discussed herein are merely illustrative of specific ways to make and use the control element and do not delimit the scope of the control element.

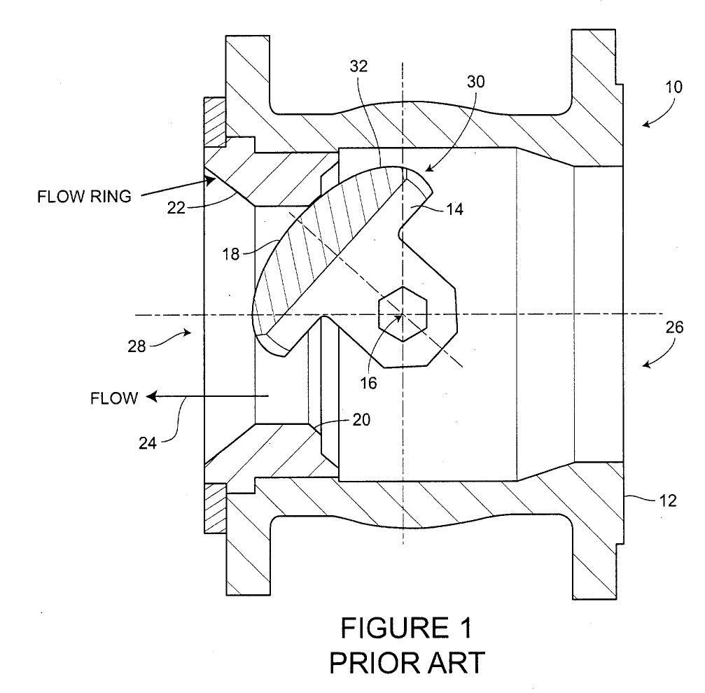

Referring now to FIG. 1, a fluid control valve 10 according to the prior art is depicted. A valve body 12 houses a control element 14, which may be rotated about the axis of a control shaft 16. A front surface 18 of the control element 14 is in frictional or close engagement with an annular seating surface 20, which may be formed, using a flow ring 22. When the fluid control valve 10 is in an open position, fluid may flow in the direction indicated by arrow 24 from an upstream orifice 26 through the flow ring 22 and into a downstream orifice 28. Low velocity flow or stagnation, however, may occur in a region 30. Consequently, scale 32 is likely to form on the front surface 18 of the control element 14 that is located in region 30 when the control element 14 is in an open position. Scale 32 may interfere with movement of the front surface 18 of the control element 14 across the annular seating surface 20 of the flow ring 22 and render the fluid control valve 10 inoperable. An inoperable fluid control valve 10 may require a process to be stopped while the fluid control valve 10 is serviced or replaced. Stopping a process for unscheduled maintenance could cause great economic loss. In some cases, an inoperable fluid control valve 10 may cause a dangerous or even life-threatening process condition.

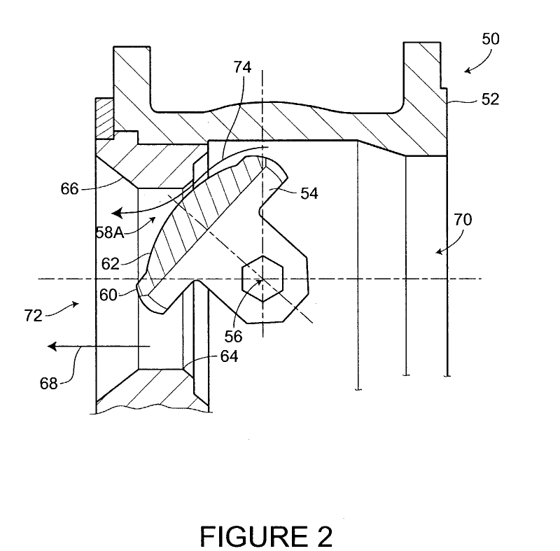

The present control element reduces or eliminates scaling caused by low velocity flow or stagnation. Turning now to one embodiment of the present control element depicted in FIG. 2, a fluid control valve 50 has a valve body 52 that houses a control element 54. The control element 54 may be rotated about the axis of a control shaft 56. A face 58A of the control element 54 has a control element seating surface 60 and a recessed surface 62. When the fluid control valve 50 is in the closed position, the control element seating surface 60 is in frictional or close engagement with an annular seating surface 64 of a flow ring 66, which may substantially reduce or stop fluid flow through the fluid control valve 50. When the fluid control valve 50 is in an open position, fluid may flow along the primary flow path 68, which generally flows from an upstream orifice 70 though the flow ring 66 and into a downstream orifice 72. Additionally, when the fluid control valve 50 is in an open position, fluid may also flow across the face 58A of the control element 54 through a secondary flow path 74.

Fluid flow across the face 58A of the control element 54 may reduce or eliminate regions of low velocity flow or stagnation, which promote scale formation. Fluid flow through the secondary flow path 74 effectively prevents or reduces scale formation on the control element seating surface 60 and recessed surface 62. The fluid control valve 50, therefore, has an increased time between service as compared to prior valves. Reducing scheduled or necessary service times increases process efficiency and ultimately conserves operating costs. The fluid control valve 50 is also less likely to bind or seize because of scale formation on the face 58A. Fluid control valve 50 is consequently safer and more reliable than prior valves.

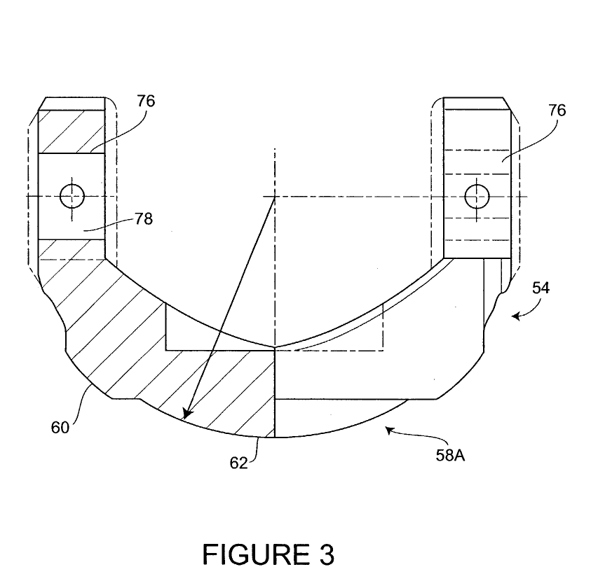

Turning now to FIGS. 3-6, the control element 54 according to one embodiment of the present control element is depicted. The control element 54 may be made from heat-treated steel, ceramic, polymer, and the like. The control element 54 may also be made from other materials that will be apparent to those having ordinary skill in the art. The control element 54 may be cast, machined from a single piece of material or fabricated from multiple materials.

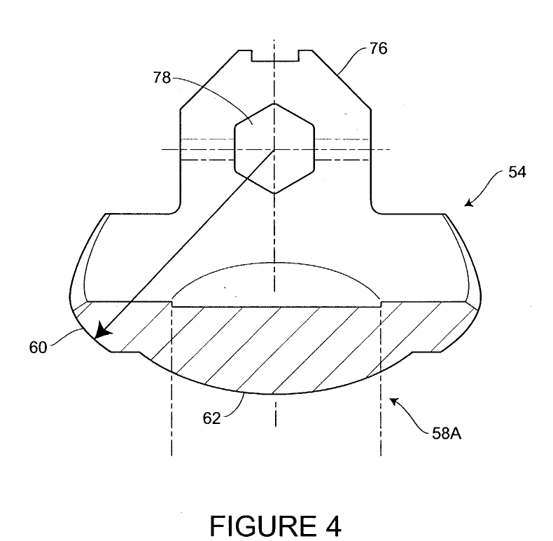

As depicted in FIG. 4, the face 58A, for example, may be fabricated separately and attached to the control element 54 by welds, screws, press-fitting, adhesives and the like. The face 58A may be removable from the control element 54 to facilitate maintenance or replacement of a worn or damaged fluid control valve 50. One or more screws (not shown) through the control element 54 may attach the face 58A to the control element 54. Ears 76 interface with the control shaft 56 through aperture 78 to move the control element 54 between open and closed positions when the control shaft 56 (depicted in FIG. 2) is rotated about its axis.

The face 58A may be made from different materials than the control element 54 or the flow ring 66 according to a particular process or application. For example, the control element 54 may be heat-treated steel and the face 58A may be a polymer to better withstand a corrosive environment, ease operation of the fluid control valve 50, or provide a particular sealing interface with the annular seating surface 64 of the flow ring 66.

The interface between the control element seating surface 60 and the annular seating surface 64 of the flow ring 66 (depicted in FIG. 2) may vary depending on the requirements of a particular process application. If the fluid flowing through the fluid control valve 50 contains extremely corrosive or erosive fluids including strongly adhering scale, a loose tolerance between the control element seating surface 60 and the annular seating surface 64 may be desired. If a particular application requires that fluid flow be completely stopped tighter tolerances between the control element seating surface 60 and the annular seating surface 64 may be specified.

Recessed surface 62 allows fluid to flow over the face 58A of the control element 54 when the control element 54 is rotated into an open position. The shape of the recessed surface 62 may be varied according to a particular process or application. Although depicted as circular, the recessed surface 62 may be oval-shaped or even a channel cut through the face 58A of the control element 54. The recessed surface 62 may be tangential to the control element seating surface 60 or generally within a single plane. Additionally, the recessed surface 62 may be concentric to or offset from the centerline of the valve body 52. Other shapes for the recessed surface 62 will be apparent to those having ordinary skill in the art of fluid dynamics.

The recessed surface 62 allows adequate flow velocity to prevent or reduce scaling between a control range of about 5 degrees to about 85 degrees of rotation of the control element 54. If the recessed surface 62 is too deep, adverse flow conditions may result in the primary flow path 68. If the recessed surface 62 is too shallow, inadequate flow velocity along the secondary flow path 74 may be conducive to scale formation. Ideal dimensions of the recessed surface 62 may be determined according to desired operating characteristics for a particular process or application.

For example, the seating surface 60 of the control element 54 may have a spherical radius of generally 3.000-(0.001 to 0.003) inches from a point on the axis of the control shaft 56 that intersects the centerline of the face 58. Referring to FIG. 2, to ensure that the control element 54 may be operated within the annular seating surface 64, which has a nominal spherical radius of 3 inches, the dimensional tolerance is biased towards the minimum diameter. The recessed surface 62 may have a spherical radius of 2.81 inches from the point on the axis of the control shaft 56 that intersects the centerline of the face 58A. The seating surface 60 begins 1.75 inches from a plane through the axis of the control shaft 56 and perpendicular to the centerline of the face 58A and ends 2.37 inches from the plane.

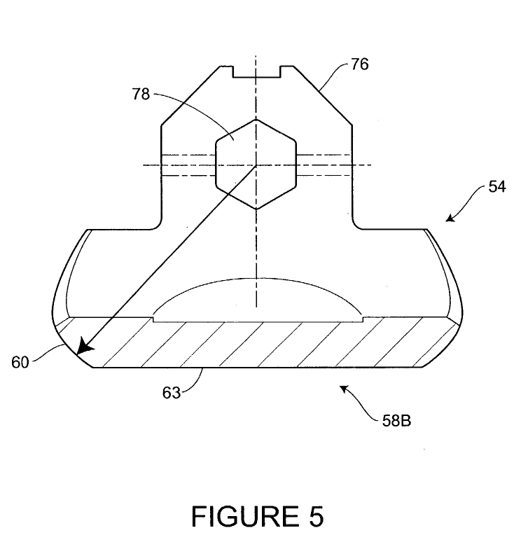

As depicted in FIG. 5, the recessed surface 63 may also be generally flat and generally parallel to the plane defined by the axis of the control shaft 56 and perpendicular to the centerline of the face 58B. The generally planar recessed surface 63 allows fluid to flow along a path that is substantially parallel to the flow in the pipe, thereby reducing impingement erosion of the valve components and the downstream pipe (not shown). The recessed surface 63 preferably allows fluid flow along the secondary flow path 74 with as little as about 5 degrees of rotation of the control element 54. The amount of rotation that will open the secondary flow path 74 is a function of the diameter or width of the recessed surface 63. The diameter or width of the recessed surface 63 also determines the area of the control element seating surface 60 that will interface the annular seating surface 64 of the flow ring 66. Consequently, the diameter or width of the recessed surface 63 may be varied according to the desired sealing and operating characteristics of the fluid control valve 50.

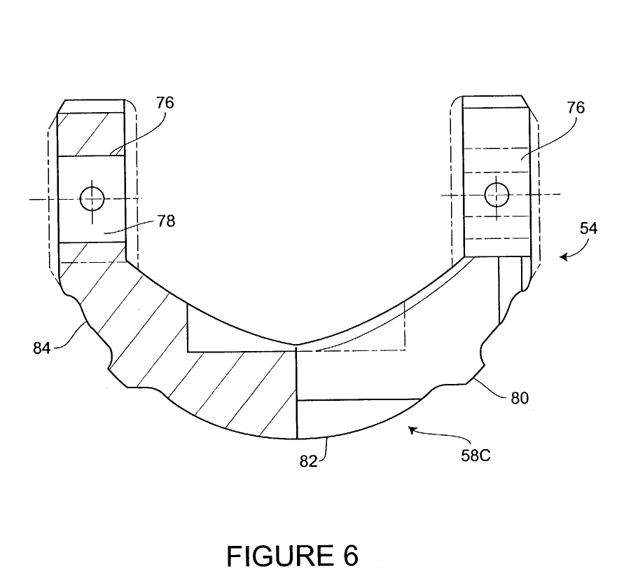

Another embodiment of the present control element 54 provides advantages when exposed to strongly adhering scale. As previously described, the interface between the control element seating surface 80 and the annular seating surface 64 of the flow ring 66 (depicted in FIG. 2) may vary depending on the requirements of a particular process application. If the fluid flowing through the fluid control valve 50 contains strongly adhering scale, a loose tolerance between the control element seating surface 80 and the annular seating surface 64 may be desired. Conversely, the embodiment depicted in FIG. 6 uses two recessed surfaces 82 and 84 placed on both sides of the seating surface 80 to create a flow path that inhibits flow stagnation and scale build up on valve component surfaces 64, 82, 84. This embodiment provides tighter tolerances between the control element seating surface 80 and the annular seating surface 64 in the presence of strongly adhering scale. The seating surface 80 of the control element 54 may have a spherical radius of approximately 3.000-(0.001 to 0.003) inches from a point on the axis of the control shaft 56 that intersects the centerline of the face 58C (as defined in FIG. 2). Additionally, the recessed surfaces 82 and 84 may have a spherical radius of 2.81 inches from the point on the axis of the control shaft 56 that intersects the centerline of the face 58C (as defined in FIG. 2).

Although this present control element has been described with reference to illustrative embodiments, this description is not intended to be construed in a limiting sense. Various modifications and combinations of the illustrative embodiments, as well as other embodiments of the present control element, will be apparent to persons skilled in the art upon reference to the description. It is therefore intended that the appended claims encompass any such modifications or embodiments.

What is claimed is:

1. A control element for a rotary control valve comprising:
at least one ear attachable to a control shaft; and
a face attached to the ear, the face having a first and a second surface, the first surface generally sealable with a valve seating surface and the second surface generally recessed from the first surface.

2. The control element according to claim 1, wherein the second surface is generally spherical and generally concentric with the first surface.

3. The control element according to claim 1, wherein the second surface is generally within a single plane.

4. The control element according to claim 1, wherein the ear and the face are formed from a single piece.

5. The control element according to claim 1, wherein the face is removably attached to the ear.

6. The control element according to claim 1, wherein the first surface is a polymer.

7. The control element according to claim 1, farther comprising a second ear rotatable about the shaft axis.

8. The control element according to claim 6, wherein end faces of the ears are substantially perpendicular to the shaft axis.

9. The control element according to claim 1, including a third surface generally recessed from the first surface wherein the diameter of the second surface less than the diameter of the first surface and the diameter of the third surface is greater than the diameter of the first surface forming a raised annular surface generally sealable with the valve seating surface.

10. A control element for a rotary control valve comprising:
a pair of ears attached to a face;
an annular surface about the perimeter of the face forming a sealable surface within the rotary control valve; and
a recessed surface on the face to promote fluid flow across the annular surface when the control element is in an open position.

11. The control element according to claim 10, wherein the recessed surface is a generally convex depression on the face.

12. The control element according to claim 10, wherein the recessed surface is generally within a single plane.

13. The control element according to claim 10, including a second recessed surface wherein the diameter of the first recessed surface is smaller in diameter than the annular surface and the diameter of the second recessed surface is larger than the diameter of the annular surface forming a raised sealable surface.

14. A rotary control valve comprising:
a valve body; and
a control element rotatable within the valve body to control fluid flow through the valve body, the control element having a first surface that is generally sealable with the valve body to generally prevent fluid flow through the valve body and a second surface generally recessed from the first surface to create a secondary flow path through the valve body.

15. The rotary control valve according to claim 14, wherein the secondary flow path generally conforms to the contour of the control element.

16. The rotary control valve according to claim 14, wherein fluid flows along the secondary flow path when the control element is rotated more than about 5 degrees.

17. The rotary control valve according to claim 14, wherein the second surface is generally spherical.

18. The rotary control valve according to claim 14, wherein the second surface is generally within a single plane.

19. The rotary control valve according to claim 14, wherein the secondary flow path generally conforms to the second surface.

20. The rotary control valve according to claim 14, including a third surface generally recessed from the first surface wherein the diameter of the second surface less than the diameter of the first surface and the diameter of the third surface is greater than the diameter of the first surface forming a raised annular surface generally sealable with the valve seating surface.
